(19) United States
(12) Patent Application Publication
(10) Pub. No.: US 2026/0226838 A1
(43) Pub. Date: Aug. 6, 2026

(54) PITCH-CHANGE MECHANISM WITH LOCKING DEVICE

(71) Applicant: Safran Aircraft Engines, PARIS (FR)

(72) Inventors: Jean Charles Olivier RODA, MOISSY-CRAMAYEL (FR); Clément COTTET, MOISSY-CRAMAYEL (FR); Ceddric BELJAMBE, MOISSY-CRAMAYEL (FR); Caroline Marie FRANTZ, MOISSY-CRAMAYEL (FR)

(73) Assignee: Safran Aircraft Engines, PARIS (FR)

(21) Appl. No.: 19/152,614

(22) PCT Filed: Jan. 31, 2024
(86) PCT No.: PCT/FR2024/050126

§ 371 Date: Jul. 31, 2025

(30) Foreign Application Priority Data
Feb. 1, 2023 (FR) FR2300921

(51) Int. Cl. F01D 7/00; B64C 11/30; B64D 27/12

(52) U.S. Cl. CPC F01D 7/00; B64C 11/30; B64D 27/12; F05D 2220/32; F05D 2220/36; F05D 2260/30; F05D 2260/70

(57) ABSTRACT

This pitch-change mechanism (70) comprises a frame (72), a movable part (102) that is translatable along a longitudinal axis (X), and a locking device (160) for immobilising the movable part (102) with respect to the frame (72). The locking device (160) comprises a movable member (210) that is translatable with respect to a locking member (164) between a retracted position in which it leaves the locking member (164) free to be in an unlocked configuration away from a surface (162) and a deployed position in which it forces the locking member (164) into a locked configuration engaged with the surface (162). It also comprises a biasing member (220) which urges the movable member (210) toward its deployed position and a holding device (222) for holding the movable member (210) in its retracted position.

### FIELD OF THE INVENTION

The present invention relates to the general field of actuators intended for controlling the orientation of variable-setting blades such as those equipping the fans of certain turbomachines.

A preferred field of application of the invention is that of turbojets with unducted fans (better known under the names “propfan”, “open fan” and “open rotor”). However, the invention also applies to turboprops with one or more pusher propellers and to ducted turbojets with variable-setting fan blades.

### TECHNOLOGICAL BACKGROUND

One of the avenues currently being explored to improve the specific consumption of civil aircraft engines is the development of unducted fan turbojets, such as that described in document FR 2 941 493. These turbojets include a conventional turboshaft gas generator, one or more turbine stages of which drive one or more unducted fans extending outside the engine nacelle.

The blades of this or these fans are, as in the case of conventional turboprops, variable-setting fans, that is to say that the angular position of these blades (called the setting angle) can be modified during flight. As a reminder, the setting angle of a blade corresponds to the angle, in a plane orthogonal to the pivot axis of the blade, between the axis of rotation of the fan and the chord of the blade at 75% of the radius of the fan. It can vary from a value substantially equal to 90°, corresponding to a position called “zero thrust position” or “flat pitch” of the blade, to a value substantially equal to 0°, corresponding to a position called “feathered” position of the blade. It can also take a value strictly greater than 90°, typically substantially equal to 95°, corresponding to a position called “reverse” position of the blade.

As is known, this modification of the setting angle during flight allows to change the engine thrust and optimize the efficiency of the fan according to the aircraft speed. Indeed, the speed of the fans is almost constant overall operating phases, and it is the setting of the blades that varies the thrust. Thus, in the cruise flight phase, the blades are oriented so as to adjust the thrust by minimizing the power taken from the turbine shaft and consumption and by optimizing efficiency. Conversely, during takeoff, the blades are oriented so as to maximize the thrust in order to accelerate then take off the aircraft.

The control of the orientation of the blades is commonly carried out by means of a pitch-change mechanism comprising a control actuator including a part that is translatable along the axis of the fan and a connection system connecting the movable part to the blade so as to convert the translation of the movable part into rotation of the variable-setting blade.

A difficulty encountered with variable-setting blades is that, in the event of a malfunction in the systems controlling their orientation, said blades tend, under their own centrifugal effect, to switch into the zero thrust position. However, a blade stuck in this position generates little resistive torque and risks causing the engine to overspeed, with potential risks of engine damage. In addition, a blade stuck in this position also risks generating excessive drag that is unacceptable for the controllability of the aircraft and/or its range in the case of a diversion mission.

To overcome this difficulty, it is known to use safety systems capable of preventing the variable-setting blades from moving toward small pitches (that is to say toward the zero thrust position) in the event of a failure of the blade orientation control system. Such a system is known, for example, from EP 3 400 169.

In particular, a safety system is known which integrates into the actuator controlling the orientation of the blades a screw-nut system of the ball screw type coupled to a locking nut. In normal operation, the nut of the screw-nut system follows the movements of the control actuator, thus causing the rotation of the screw around its axis, while the locking nut follows the thread of the screw without ever touching it (the tapping of the locking nut is designed to provide a slight clearance with the thread of the screw). In the event of a malfunction of the blade orientation control system, the screw of the screw-nut system is immobilized (its rotation is locked) and the locking nut engages with said screw, thus preventing the pivoting of the blades toward the small pitches.

However, this safety system is not entirely satisfactory. For it to work properly, it requires precise and complex management of the clearances between the locking nut and the screw thread.

### DISCLOSURE OF THE INVENTION

One purpose of the invention is to enable, in a simple and robust manner, the locking of the blade setting angle in at least one direction. Other purposes are to enable the locking of the blade setting angle in their current orientation (with a certain tolerance), to enable locking in the absence of power supply to the actuator, to enable locking and/or unlocking with a low force, and to limit the size of the locking mechanism.

To this end, the invention relates, according to a first aspect, to a pitch-change mechanism for adjusting an angular position of at least one variable-setting blade of an aircraft turbomachine around a pivot axis of the blade, said pitch-change mechanism comprising:
a frame fixed relative to the pivot axis,
a control actuator including a fixed part integral with the frame and a movable part that is translatable along a longitudinal axis with respect to the fixed part between a retracted position and a deployed position,
a connecting system connecting the movable part to the variable-setting blade so as to convert the translation of the movable part along the longitudinal axis into a rotation of the variable-setting blade around the pivot axis, and
a pitch locking device suitable for locking the translation of the movable part with respect to the fixed part in at least one direction,
   wherein the pitch locking device comprises:
a surface integral with the frame or movable jointly with the movable part with respect to the frame,
a locking member having an unlocked configuration away from the surface and a locked configuration engaged with the surface such that the movable part is immobilized with respect to the frame,
a movable member that is translatable with respect to the locking member between a retracted position in which it leaves the locking member free to be in its unlocked configuration and a deployed position in which it forces the locking member into its locked configuration,
a biasing member which urges the movable member toward its deployed position, and
a holding device for holding the movable member in its retracted position under certain predetermined conditions.

According to particular embodiments of the invention, the pitch-change mechanism also has one or more of the following features, taken in isolation or in any technically possible combination(s):
the predetermined conditions consist of a supply pressure of the chambers of the control actuator greater than a threshold;
the holding device comprises a counterbalancing cylinder with a counterbalancing chamber in contact with a piston integral with the movable member, capable of receiving a pressurized fluid to counterbalance the urge of the biasing device;
the counterbalancing chamber is partly delimited by the locking member;
the surface is movable jointly with the movable part with respect to the frame and is preferably integral with the movable part, the locking member being substantially fixed along the longitudinal axis with respect to the frame;
one of the surface and the locking member is interposed between the longitudinal axis and the other of the surface and the locking member;
the locking member comprises at least one deformable element, elastically deformable, having at rest a first radial thickness and, when compressed parallel to the longitudinal axis, a second radial thickness greater than the first radial thickness, the locking member being in the unlocked configuration when the deformable element is at rest and in the locked configuration when the deformable element is compressed parallel to the longitudinal axis;
the locking member comprises a plurality of deformable elements juxtaposed to each other parallel to the longitudinal axis;
the or each deformable element has, at rest, a longitudinal dimension less than or equal to five times, for example less than or equal to twice, its radial thickness;
the locking member is interposed, in the direction of translation of the movable member, between the movable member and a stop so that the or each deformable element is compressed between the movable member and the stop when the movable member is in the deployed position, the or each deformable element preferably being at rest when the movable member is in the retracted position;
the or each deformable element is formed from a material having a strictly positive Poisson's ratio, preferably greater than 0.4, advantageously greater than 0.45, for example greater than 0.49;
the or each deformable element is formed from polyurethane;
the or each deformable element is annular;
the surface is cylindrical and preferably substantially coaxial with the longitudinal axis;
the deformable element is substantially coaxial with the surface;
the locking device is housed inside the control actuator, the locking member preferably being housed in a piston of the control actuator; and
the locking device is arranged radially outside the control actuator and preferably surrounds the control actuator.

The invention also relates, according to a second aspect, to a fan rotor for a turbomachine comprising a hub and a plurality of variable-setting blades each pivotable relative to the hub around a specific pivot axis, the rotor further comprising a pitch-change mechanism according to the first aspect for adjusting an angular position of each of the variable-setting blades around its respective pivot axis.

According to a particular embodiment of the invention, the fan rotor also has the following feature:
the longitudinal axis constitutes an axis of rotation of the rotor.

The invention also relates, according to a third aspect, to a gas turbine engine comprising a fan rotor according to the second aspect.

According to a particular embodiment of the invention, the gas turbine engine also has the following feature:
the longitudinal axis constitutes an axis of elongation of the gas turbine engine.

The invention also relates, according to a fourth aspect, to an aircraft comprising at least one gas turbine engine according to the third aspect.

Finally, the invention relates, according to a fifth aspect, to a method for changing the pitch of the blades of a fan rotor for a turbomachine, each pivotable relative to a hub of the fan rotor around a specific pivot axis, said method comprising adjusting an angular position of each of said blades around its respective pivot axis by means of a pitch changing mechanism according to the first aspect.

According to a particular embodiment of the invention, the method also has the following feature:
the method comprises an additional step of locking the orientation of the blades by means of the pitch locking device.

### BRIEF DESCRIPTION OF THE FIGURES

Other features and advantages of the invention will appear upon reading the description which follows, given only by way of example and made with reference to the appended drawings, in which:

FIG. 1 is a top view of an aircraft according to an exemplary embodiment of the invention,

FIG. 2 is a simplified longitudinal sectional view of a gas turbine engine of the aircraft of FIG. 1,

FIG. 3 is a partial simplified view, in longitudinal section, of a first variant of a pitch-change mechanism of the gas turbine engine of FIG. 2,

FIG. 4 is a view of a detail marked IV of FIG. 3, a pitch locking device of the pitch-change mechanism being in a first configuration,

FIG. 5 is a view similar to that of FIG. 4, with the pitch locking device in a second configuration,

FIG. 6 is a simplified view along a radial axis of a rotating arm of a variable-setting blade of the turbomachine of FIG. 2,

FIG. 7 is a view similar to that of FIG. 3 of a second variant of a pitch-change mechanism of the gas turbine engine of FIG. 2, and

FIG. 8 is a view of a detail marked VIII of FIG. 7, a pitch locking device of the pitch-change mechanism being in a first configuration, and

FIG. 9 is a view similar to FIG. 8 with the pitch locking device in a second configuration.

### DETAILED DESCRIPTION OF AN EXEMPLARY EMBODIMENT

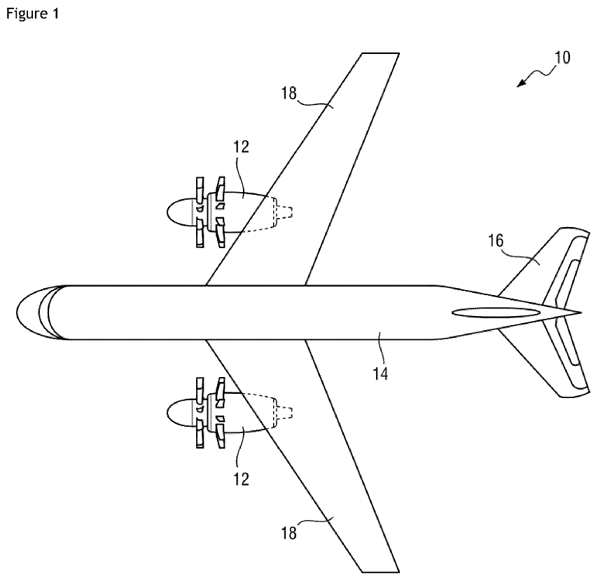

The aircraft 10 shown in FIG. 1 comprises turbomachines 12 forming gas turbine engines to propel it.

In the example shown, the aircraft 10 is an airplane. This aircraft comprises, in a conventional manner, a fuselage 14, a tailplane 16 and two wings 18. The gas turbine engines 12 are here two in number and are each housed under a respective wing 18. As a variant (not shown), the gas turbine engines 12 are arranged along the fuselage 14, for example near the tailplane 16. As a further variant (also not shown), the aircraft 10 comprises a single gas turbine engine 12 or at least three gas turbine engines 12.

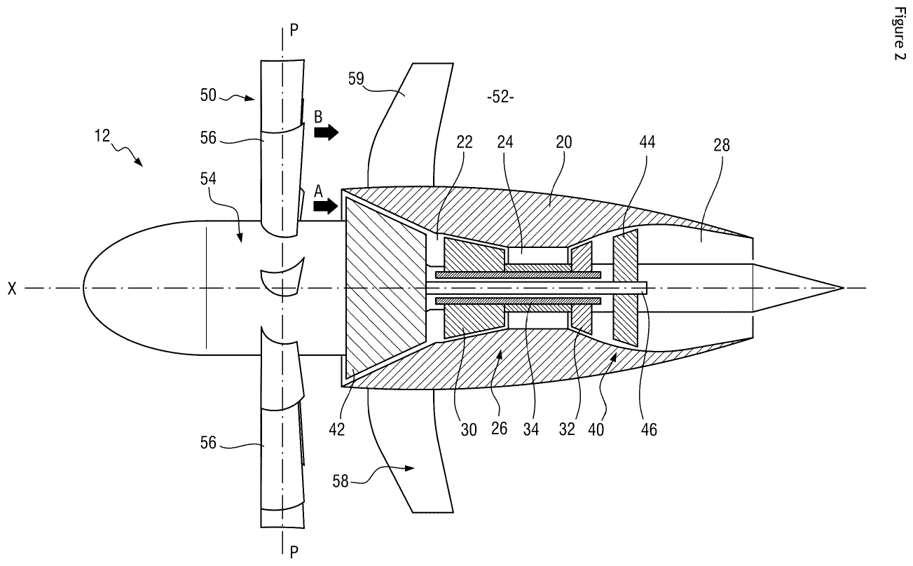

One of the turbomachines 12 is shown in FIG. 2.

As visible in this FIG. 2, the turbomachine 12 is elongated along a longitudinal axis X. It typically has an angular symmetry around said longitudinal axis X, that is to say that there is at least one angle for which the turbomachine is invariant by rotation around the longitudinal axis X.

Here and hereinafter, the terms “interior” and “exterior”, “internal” and “external”, as well as their variations, are understood in reference to the axis X, an element described as “interior” or “internal” being oriented toward the axis X while an “exterior” or “external” element is oriented opposite the axis X.

The turbomachine 12 comprises, in a conventional manner, a nacelle 20, an internal flow path 22 for circulating an air flow through the nacelle 20, a combustion chamber 24 housed in the flow path 22, an engine spool 26 and a gas exhaust nozzle 28.

In the following, the terms “upstream” and “downstream” are understood to refer to a direction of flow of an air flow through the flow path 22.

The engine spool 26 comprises a compressor 30, a turbine 32 and a transmission shaft 34 coupling the turbine 32 to the compressor 30 for driving the compressor 30 by the turbine 32. The compressor 30 is arranged upstream of the combustion chamber 24 and supplies the combustion chamber 24 with compressed air. The turbine 32 is arranged downstream of the combustion chamber 24 and receives the exhaust gases leaving the combustion chamber 24.

The transmission shaft 34 has the longitudinal axis X as its axis of rotation.

The transmission shaft 34 is guided in rotation relative to the nacelle 20 by means of bearings (not shown).

In the example shown, the turbomachine 12 is a multi-spool turbomachine, in particular a twin-spool turbomachine, comprising a low-pressure spool 40 in addition to the engine spool 26. The engine spool 26 then constitutes a high-pressure spool, the compressor 30 being a high-pressure compressor, the turbine 32 being a high-pressure turbine and the transmission shaft 34 being a high-pressure shaft.

The low-pressure spool 40 comprises a low-pressure compressor 42, a low-pressure turbine 44 and a low-pressure shaft 46 coupling the low-pressure turbine 44 to the low-pressure compressor 42 for driving the low-pressure compressor 42 by the low-pressure turbine 44.

The low-pressure compressor 42 is arranged upstream of the high-pressure compressor 30 and supplies the latter with compressed air. The low-pressure turbine 44 is arranged downstream of the high-pressure turbine 32 and receives the exhaust gases leaving the latter.

The low-pressure shaft 46 is guided in rotation relative to the nacelle 20 by means of bearings (not shown).

The low-pressure shaft 46 is coaxial with the high-pressure shaft 34. Therefore, it also has the longitudinal axis X as its axis of rotation. In particular, the low-pressure shaft 46 extends inside the high-pressure shaft 34.

The turbomachine 12 also comprises a fan 50 for driving the air flow in an external circulation flow path 52 surrounding the nacelle 20. A primary (hot) air flow A is thus distinguished, consisting of the portion of the air flow driven in the internal circulation flow path 22, and a secondary (cold) air flow B, consisting of the portion of the air flow driven in the external circulation flow path 52.

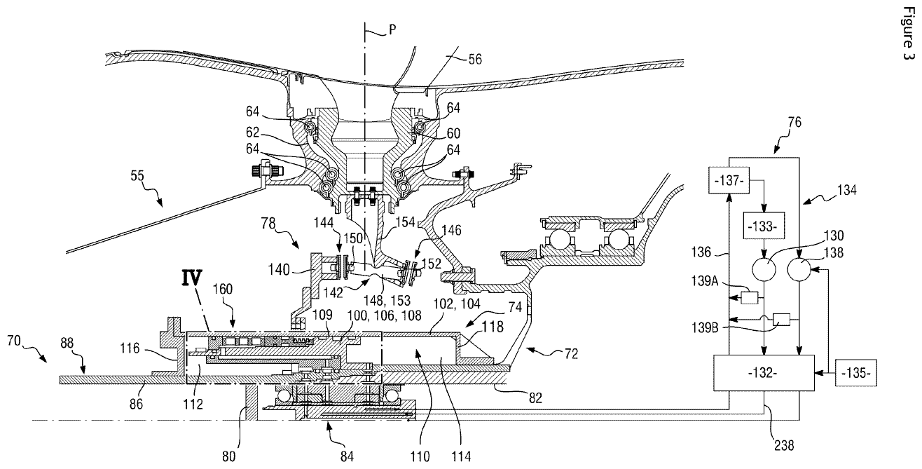

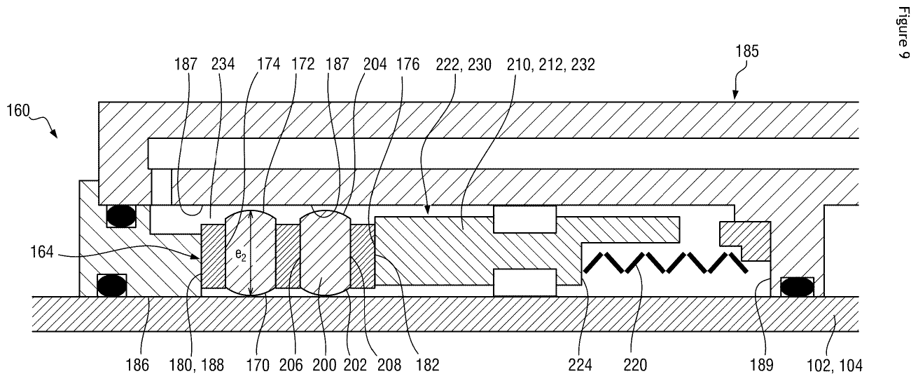

The fan 50 comprises a fan rotor 54. This fan rotor 54 is rotatably mounted relative to the nacelle 20 around the longitudinal axis X. It comprises a hub 55 (FIGS. 3 and 9) provided with fan blades 56 extending substantially radially outward from the hub 55. These blades 56, when rotated, drive the air flow in the external circulation flow path 52.

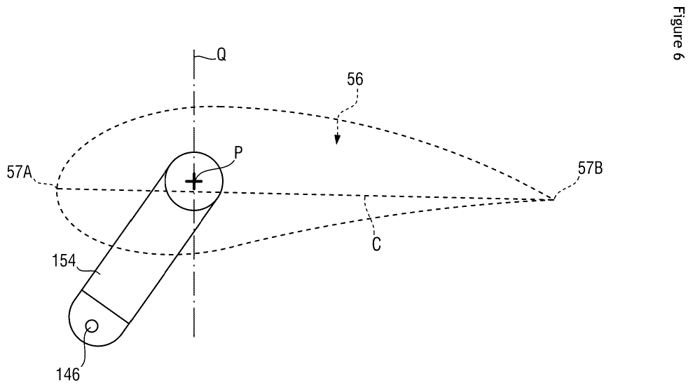

As seen in FIG. 6, each blade 56 comprises a leading edge 57A, a trailing edge 57B and a chord C connecting the leading edge 57A to the trailing edge 57B.

Returning to FIG. 2, the fan rotor 54 is driven in rotation by the low-pressure turbine 44, via the low-pressure shaft 46. This drive is preferably done via a reducer (not shown) allowing the fan rotor 54 to rotate at a speed lower than that of the low-pressure shaft 46. Alternatively, this drive is direct, that is to say that the fan rotor 54 is integral in rotation with the low-pressure shaft 46.

In the example shown, the fan 50 also comprises a fan stator 58 comprising fixed blades 59 arranged at the periphery of the nacelle 20, in the external circulation flow path 52, along a plane orthogonal to the longitudinal axis X. This fan stator 58 is here arranged downstream of the fan rotor 54. As a variant (not shown), the fan 50 comprises, instead of the fan stator 58, a counter-rotating fan rotor.

Advantageously, the fan 50 is, as shown, unducted, that is to say that the external circulation flow path 52 has no peripheral delimitation. The turbomachine 12 is then constituted, as shown, by a turbojet engine with an unducted fan or, as a variant, by a turboprop. As a variant (not shown), the external circulation flow path 52 is defined between the nacelle 20 and a fan casing surrounding the fan 50; the turbomachine 12 is then typically constituted by a turbojet engine with a high bypass ratio, the bypass ratio being defined as the ratio of the flow rate of the secondary (cold) flow B to the flow rate of the primary (hot) flow A.

In the example shown, the turbomachine 12 is in particular of the “puller” type, that is to say that the fan 50 is arranged upstream of the internal circulation flow path 22 and also drives the air flow in the latter. As a variant (not shown), the turbomachine is of the “pusher” type, that is to say that the fan 50 is placed around the downstream half of the nacelle 20.

The blades 56 of the fan rotor 54 are variable-setting blades, that is to say that each blade 56 is pivotally mounted relative to the hub 55 around a specific pivot axis P. This pivot axis P extends in the direction of elongation of the blade 56. It is orthogonal to the longitudinal axis X.

Each blade 56 is in particular able to pivot around the axis P relative to the hub 55 between a position called feathered position, in which the chord C of the blade 56 is substantially parallel to the longitudinal axis X, and a position called zero thrust position, in which the chord C of the blade 56 is substantially orthogonal to the longitudinal axis X. Preferably, each blade 56 is also able to pivot beyond the zero thrust position, to a position called reverse position, in which the chord C of the blade 56 forms an angle strictly greater than 90°, for example substantially equal to 95°, with the longitudinal axis X. The blades 56 being most often twisted, the chord C taken as a reference for measuring the setting angle is, by convention, constituted by the chord of the blade at 75% of the radius of the fan rotor 54.

For this purpose, each blade 56 is integral, as visible in FIGS. 3 and 9, with an attachment component 60 arranged at the blade root. This attachment component 60 is rotatably mounted relative to the hub 55 around the pivot axis P. More precisely, the attachment component 60 is rotatably mounted inside a housing 62 formed in the hub 55 by means of balls 64 or other rolling elements.

The fan 50 further comprises a pitch-change mechanism 70 for adjusting the setting angle of each blade 56 around its pivot axis P so as to adapt the performance of the turbomachine 12 to the different phases of flight.

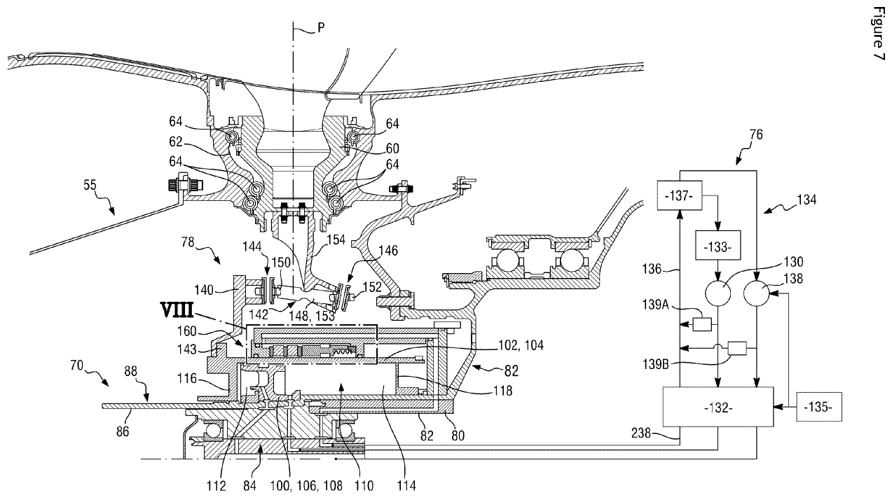

With reference to FIGS. 3 and 7, this pitch-change mechanism 70 comprises a frame 72, a control actuator 74, a system 76 for controlling the actuator 74 and a connection system 78.

The frame 72 is integral with the hub 55 and is typically constituted by a part of the hub 55. It is thus fixed relative to the pivot axes P.

The frame 72 comprises a base 80. This base 80 is centered on the longitudinal axis X. Here, it is traversed by the pivot axes P.

In the example shown, the base 80 delimits a housing 82 open downstream. This housing 82 is in particular cylindrical, typically cylindrical of revolution, and centered on the axis X. An oil transfer bearing 84 is received in said housing 82.

In the example shown, the frame 72 also comprises a cylinder 86 projecting upstream from the base 80. This cylinder 86 is centered on the axis X. It is typically cylindrical of revolution.

The base 80 and the peripheral cylinder 86 together delimit an external peripheral surface 88 of the frame 72. This external peripheral surface 88 is substantially cylindrical and centered on the axis X. It is oriented radially outwards.

The control actuator 74 includes a fixed part 100, integral with the frame 72, and a movable part 102 that is translatable along the longitudinal axis X with respect to the fixed part 100 between a retracted position, shown in FIGS. 3 and 7, and a deployed position (not shown). Optionally, the movable part 102 is also rotatably movable around the longitudinal axis X over a restricted angle, for example of the order of 5°.

The control actuator 74 comprises in particular a continuous cylinder 104, forming one of the fixed part 100 and the movable part 102 and a piston 106 forming the other of the fixed part 100 and the movable part 102. Here, the cylinder 104 forms the movable part 102 and the piston 106 forms the fixed part 100. As a variant (not shown), the opposite is true: the cylinder 104 forms the fixed part 100 and the piston 106 forms the movable part 102.

Thus, in the example shown, the cylinder 104 extends around the external peripheral surface 88 of the frame 72, coaxially with the latter, and the piston 106 is constituted by a collar 108 integral with the frame 72 extending radially outwards from the external peripheral surface 88 to the cylinder 104.

The piston 106 has an external face 109 in contact with the cylinder 104.

The cylinder 104 defines an internal cavity 110. The piston 106 divides said internal cavity 110 into two contiguous fluid chambers 112, 114. Each contains a control fluid, typically constituted by an oil, for controlling the movement of the movable part 102 with respect to the fixed part 100. This control fluid is at a first pressure in the first fluid chamber 112 and at a second pressure in the second fluid chamber 114. The first and second fluid chambers 112, 114 are arranged such that the relative increase in the first pressure (that is to say, relative to the second pressure) causes the piston 110 to move toward its deployed position, the relative increase in the second pressure (that is to say, relative to the first pressure) causes the piston 110 to move toward its retracted position.

Here, each of the fluid chambers 112, 114 is delimited internally by the external peripheral surface 88 of the frame 72 and externally by the cylinder 104. The first fluid chamber 112 is moreover delimited at its downstream end by the piston 106 and the second fluid chamber 114 is delimited at its upstream end by the piston 106.

The control actuator 74 is thus particularly compact, which makes it lighter.

In the example shown, the movable part 102 also comprises an upstream guide ring 116 and a downstream guide ring 118 each integral with the cylinder 104 and extending radially inwards from the cylinder 104 to the external peripheral face 88 of the frame 72. The upstream guide ring 116 is arranged upstream of the piston 106 and delimits an upstream end of the first fluid chamber 112. The downstream guide ring 118 is arranged downstream of the piston 106 and delimits a downstream end of the second fluid chamber 114.

In the example shown, each of the upstream and downstream guide rings 116, 118 constitutes a sealing ring and longitudinally closes the first fluid chamber 112, respectively the second fluid chamber 114. The fluid chambers 112, 114 are thus closed at each of the longitudinal ends of the control actuator 74.

As a variant (not shown), only the downstream guide ring 118 constitutes a sealing ring. The upstream guide ring 116 has holes allowing the control fluid to flow through the upstream guide ring 116.

As a further variant (not shown), the movable part 102 does not comprise an upstream guide ring 116.

The control system 76 comprises a pressure generator 130 for bringing the control fluid to a third pressure higher than the first and second pressures, a pressure control unit 132 for adjusting the pressure of the control fluid in the first and second fluid chambers 112, 114 by means of the third pressure, and a return line 136 for discharging the depressurized control fluid. The control system 76 also comprises a main reservoir 133, a backup circuit 134 and a control module 135.

The pressure generator 130 comprises, for example, a pump capable of pumping the fluid to bring it to the third pressure, for example 100 bars. A main pressure relief valve 139A allows to evacuate part of the control fluid to the return line 136 when the pressure of the control fluid downstream of the pressure generator 130 exceeds the third pressure.

The pressure control unit 132 is supplied with control fluid at the third pressure by the pressure generator 130. It is fluidically connected to the first fluid chamber 112 and to the second fluid chamber 114 via the oil transfer bearing 84. It is able to distribute the control fluid between the first fluid chamber 112 and the second fluid chamber 114 so as to adjust the fluid pressure inside each of these chambers 112, 114 and, thus, adjust the position of the piston 110 between its retracted and deployed positions. It is also able to discharge control fluid from the first and second fluid chambers 112, 114 into the return line 136.

The main reservoir 133 is configured to collect depressurized control fluid from the return line 136. It supplies the pressure generator 130.

The emergency circuit 134 is capable of supplying the first fluid chamber 112 with control fluid so as to move the piston 110 toward its deployed position in the event of failure of the pressure generator 130. For this purpose, the emergency circuit 134 comprises an auxiliary reservoir 137 and an auxiliary pump 138. In the example shown, it also comprises an auxiliary pressure relief valve 139B.

The auxiliary reservoir 137 is configured to collect depressurized control fluid from the return line 136. It feeds the auxiliary pump 138. In the example shown, it also feeds the main tank 133, with the depressurized control fluid from the return line 136 passing through the auxiliary reservoir 137 before reaching the main tank 133.

The auxiliary pump 138 is capable of pumping the control fluid into the auxiliary reservoir 137 to bring it to the third pressure. It is fluidically connected to the pressure control unit 132 so as to supply it with control fluid at the third pressure, the pressure control unit 132 being configured to redirect all the control fluid coming from the auxiliary pump 138 to the first fluid chamber 112.

The pressure relief valve 139B is adapted to discharge part of the control fluid to the return line 136 when the pressure of the control fluid downstream of the auxiliary pump 138 exceeds the third pressure.

The control module 135 is configured to receive a setting instruction (not shown) and deduce therefrom a control signal transmitted to the pressure control unit 132. In particular, the control module 135 is configured to transmit to the pressure control unit 132 a control signal intended to increase the fluid pressure in the first chamber 112 when the setting instruction aims at increasing the pitch of the blades 56, and to transmit to the pressure control unit 132 a control signal intended to increase the fluid pressure in the second chamber 114 when the setting instruction aims at reducing the pitch of the blades 56.

The control module 135 is also configured to transmit to the emergency circuit 134, more particularly to its auxiliary pump 138, a start instruction in the event of failure of the pressure generator 130.

The connecting system 78 connects the movable part 102 to each blade 56 so as to convert the translation of the movable part 102 along the longitudinal axis X and, where appropriate, the rotation of the movable part 102 around the longitudinal axis X into a rotation of each blade 56 around its pivot axis P. In particular, the connecting system 78 connects the movable part 102 to each blade 56 so as to convert:
the translation of the movable part 102 along the longitudinal axis X in a first direction into a rotation of the variable-setting blade 56 around the pivot axis P toward the zero thrust position, and
the translation of the movable part 102 along the longitudinal axis X in a second direction opposite to the first direction into a rotation of the variable-setting blade 56 around the pivot axis P toward the feathered position.

For this purpose, the connection system 78 comprises a synchronization ring 140 integral with the movable part 102 and, for each of the blades 56, a mechanism 142 for connecting the blade 56 to the synchronization ring 140.

The synchronization crown 140 extends in a radial plane around the movable part 102. In the exemplary embodiment of FIGS. 3 to 5, it is fixed to a middle portion of the movable part 102. In the exemplary embodiment of FIGS. 7 to 9, it is fixed to an upstream end 143 of the movable part 102.

Each connecting mechanism 142 comprises a first articulation 144 integral with the movable part 102, a second articulation 146 integral with the blade 56, away from the pivot axis P of said blade 56, and a connecting member 148 connecting the first articulation 144 to the second articulation 146.

The first articulation 144 is carried by the synchronization crown 140. Here it is constituted by a ball joint.

The second articulation 146 is also constituted by a ball joint. It is eccentric relative to the pivot axis P.

The connecting member 148 has a first end 150 articulated to the first articulation 144 and a second end 152 articulated to the second articulation 146. Advantageously, the connecting member 148 is rigid and of adjustable length, that is to say that the distance between the first and second ends 150, 152 can be modified, which allows to precisely adjust the length thereof when stationary so as to allow the control of the setting angle of each blade 56 by the pitch-change mechanism 70.

The connecting member 148 is here constituted by a connecting rod 153.

In the example shown, each connecting mechanism 142 also comprises a crank 154 connecting the attachment component 60 to the second articulation 146. This crank 154 is rigid and integral with the attachment component 60. It extends at least partly in a direction orthogonal to the pivot axis P. It forms an arm for rotating the blade 56.

In the example shown, the first direction is from upstream to downstream, that is to say that the movement of the movable member 102 toward its retracted position causes a rotation of each blade 56 toward its zero thrust position, and the second direction is from downstream to upstream, that is to say that the movement of the movable member 102 toward its deployed position causes a rotation of each blade 56 toward its feathered position. In addition, the first articulation 144 is arranged upstream of the second articulation 146.

For this purpose, the second articulation 146 is, as visible in FIG. 6, placed opposite the trailing edge 57B relative to a plane Q orthogonal to the chord C and containing the pivot axis P.

As a variant (not shown), the first direction goes from downstream to upstream, the first articulation 144 being arranged downstream of the second articulation 146. The second articulation 146 is then placed on the same side of the trailing edge 57B relative to the plane Q orthogonal to the chord C and containing the pivot axis P.

These particular arrangements allow, when the pitch-change mechanism 70 is immobilized, that the natural urges of the blade 56 toward its zero thrust position cause the connecting member 148 to work in tension and not in compression. The risk of buckling of the connecting member 148 is therefore very low, so that it is possible to use a relatively weak connecting member 148 and thus to lighten the pitch-change mechanism 70.

The pitch-change mechanism 70 further comprises a pitch locking device 160 capable of locking the translation of the movable part 102 of the control actuator 74 in both directions, that is to say both toward its retracted position and toward its deployed position.

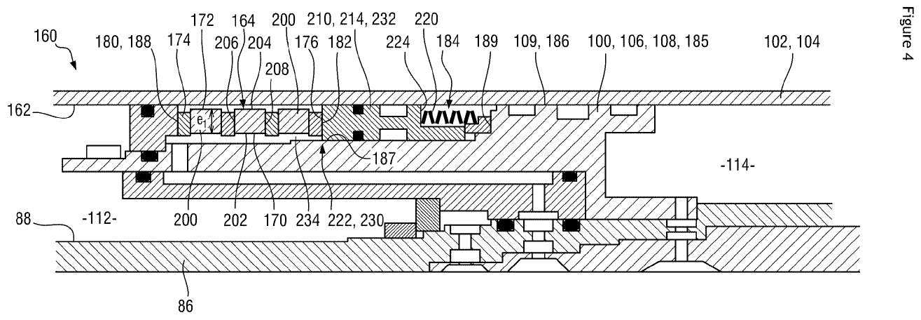

With reference to FIGS. 4, 5, 8 and 9, the locking device 160 comprises a cylindrical surface 162 movable together with the movable part 102 with respect to the fixed part 100 and a locking member 164 for immobilizing the movable part 102 with respect to the fixed part 100 by engaging the cylindrical surface 162.

The cylindrical surface 162 is in particular integral with the movable part 102.

The cylindrical surface 162 is advantageously, as shown, substantially coaxial with the axis X.

Here, the cylindrical surface 162 is carried directly by the movable part 102. In the exemplary embodiment of FIGS. 3 to 5, it constitutes an internal surface of the cylinder 104. In the exemplary embodiment of FIGS. 7 to 9, it constitutes an external surface of said cylinder 104.

Typically, the cylindrical surface 162 is substantially smooth.

The locking member 164 has an internal radial face 170, oriented radially toward the axis X and radially delimiting the locking member 164 inwards, and an external radial face 172, oriented radially opposite the axis X and radially delimiting the locking member 164 outwards. It also has an upstream longitudinal face 174, oriented longitudinally upstream and longitudinally delimiting the locking member 164 upstream, and a downstream longitudinal face 176, oriented longitudinally downstream and longitudinally delimiting the locking member 164 downstream.

The locking member 164 is positioned relative to the cylindrical surface 162 such that one of the locking member 164 and the cylindrical surface 162 is interposed between the axis X and the other of the locking member 164 and the cylindrical surface 162. Thus, in the exemplary embodiment of FIGS. 3 to 5, the locking member 164 is interposed between the axis X and the cylindrical surface 162 and, in the exemplary embodiment of FIGS. 7 to 9, the cylindrical surface 162 is interposed between the axis X and the locking member 164.

Here, the locking member 164 is annular and substantially coaxial with the cylindrical surface 162. It is therefore positioned relative to the cylindrical surface 162 so that one of the locking member 164 and the cylindrical surface 162 surrounds the other of the locking member 164 and the cylindrical surface 162. In particular, in the exemplary embodiment of FIGS. 3 to 5, the cylindrical surface 162 surrounds the locking member 164 and, in the exemplary embodiment of FIGS. 7 to 9, the locking member 164 surrounds the cylindrical surface 162.

The locking member 164 is substantially fixed in the longitudinal direction (that is to say parallel to the axis X) with respect to the frame 72. For this purpose, it is here embedded between two radial stops 180, 182 facing each other and limiting the longitudinal movements of the locking member 164 with respect to the frame 72. These stops 180, 182 comprise an upstream stop 180, arranged upstream of the locking member 164, and a downstream stop 182, arranged downstream of the locking member 164. Here, the upstream longitudinal edge 174 is in contact with the upstream stop 180 and the downstream longitudinal edge 176 is in contact with the downstream stop 182.

One of the stops 180, 182, here the upstream stop 180, is integral with the frame 72.

In particular, the locking member 164 is housed in a recess 184, here an annular recess centered on the axis X, of a support 185 integral with the frame 72. This recess 184 opens into a face 186 of said support 185 which faces the cylindrical surface 162. It is delimited by a bottom 187 set back relative to said face 186 and two radial shoulders 188, 189 connecting the bottom 187 to the face 186, one of said shoulders 188 delimiting the stop 180.

In the embodiment of FIGS. 3 to 5, where the locking device 160 is housed inside the control actuator 74, said support 185 is constituted by the piston 106, the face 186 being constituted by the external face 109 of said piston 106.

In the embodiment of FIGS. 7 to 9, where the locking device 160 is arranged radially outside the control actuator 74 and in particular surrounds the control actuator 74, the support 185 is arranged radially outside the locking member 164 and the control actuator 74. It is in particular cylindrical and extends around the locking member 164. The face 186 constitutes an internal face, oriented toward the axis X, of said support 185 and which is here in contact with the cylinder 104.

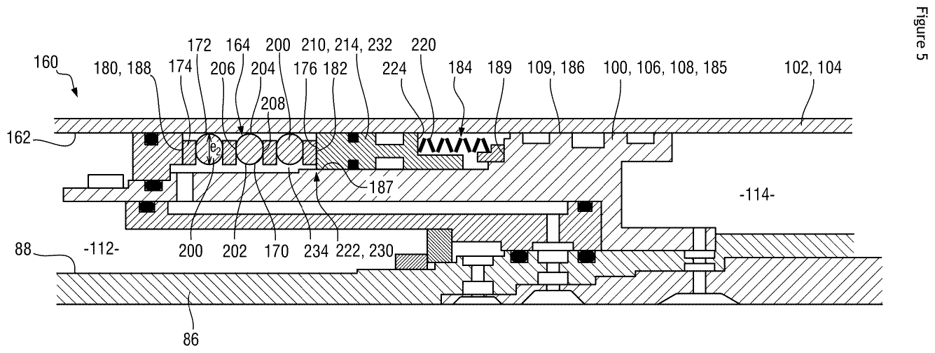

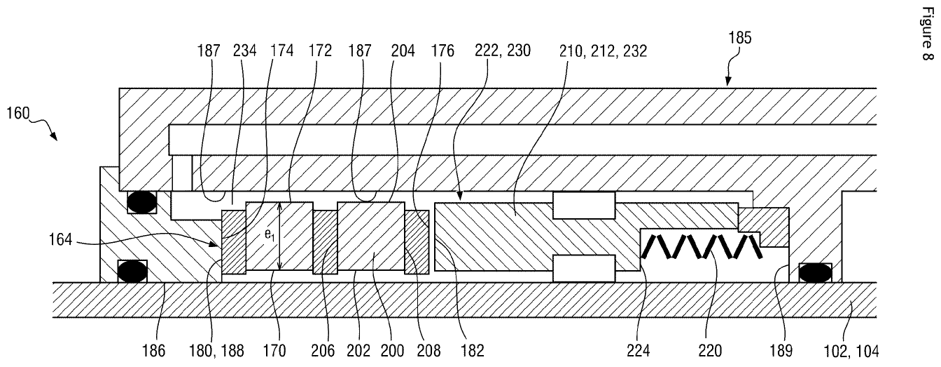

The locking member 164 has a first configuration, shown in FIGS. 4 and 8, in which it is away from the cylindrical surface 162, and a second configuration, shown in FIGS. 5 and 9, in which its internal radial face 170 is displaced radially inwards and/or its outer radial face 172 is displaced radially outwards so that the locking member 164 is engaged with the cylindrical surface 162, the movable part 102 being immobilized with respect to the frame 72. The second configuration thus constitutes a locked configuration of the locking member 164, the first configuration constituting an unlocked configuration.

For this purpose, the locking member 164 comprises a plurality of deformable elements 200 juxtaposed to each other parallel to the longitudinal axis X.

Each deformable element 200 has an internal radial edge 202, oriented radially toward the axis X and radially delimiting the deformable element 200 inwards, and an external radial edge 204, oriented radially opposite the axis X and radially delimiting the deformable element 200 outwards. It also has an upstream longitudinal edge 206, oriented longitudinally upstream and longitudinally delimiting the deformable element 200 upstream, and a downstream longitudinal edge 208, oriented longitudinally downstream and longitudinally delimiting the deformable element 200 downstream.

The internal radial edges 202 of the deformable elements 200 together form the internal face 170 of the locking member 164. The external radial edges 204 of the deformable elements 200 together form the external face 172 of the locking member 164.

In the example shown, each deformable element 200 is annular. The internal radial edge 202 of each deformable element 200 therefore constitutes an internal edge of said deformable element 200 and the external radial edge 204 of each deformable element 200 constitutes an external edge of said deformable element 200. Each deformable element 200 is furthermore substantially coaxial with the cylindrical surface 162.

Each deformable element 200 is preferably formed in one piece. Alternatively, each deformable element 200 is formed of several segments spaced circumferentially from each other.

Each deformable element 200 is elastically deformable so that, at rest, it has a first radial thickness e₁ (FIGS. 4 and 8) and, when it is compressed parallel to the longitudinal axis X, it has a second radial thickness e₂ (FIGS. 5 and 9) greater than the first radial thickness e₁, said radial thicknesses e₁, e₂ being measured between the internal radial edge 202 and the external radial edge 204 of the deformable element 200. The locking member 164 is thus in the locked configuration when the deformable elements 200 are compressed parallel to the longitudinal axis X and in the unlocked configuration when the deformable elements 200 are at rest (or, at least, when the compression force is released).

For this purpose, each deformable element 200 is formed and is preferably made of a material having a strictly positive Poisson's ratio. Thus, each deformable element 200 expands radially when it is compressed longitudinally. Said Poisson's ratio is preferably greater than 0.4, advantageously greater than 0.45 and for example greater than 0.49. Thus, the expansion of each deformable element 200 under the effect of compression occurs at almost constant volume, which limits the longitudinal size.

The material of each deformable element 200 is also chosen so as to have a high coefficient of adhesion, that is to say greater than 0.1.

Said material is typically a polyurethane.

Preferably, when at rest, each deformable element 200 has, as shown, a longitudinal dimension (measured between its longitudinal edges 206, 208) less than or equal to five times, for example less than or equal to twice its radial thickness e₁. This prevents any buckling of the deformable element 200 under the effect of compression and allows the variation in thickness of the deformable element 200 to result purely from a radial expansion of the deformable element 200.

Still with reference to FIGS. 4, 5, 8 and 9, the locking device 160 also comprises a movable member 210, that is translatable with respect to the frame 72 and to the locking member 164 between a retracted position, shown in FIGS. 4 and 8, in which it leaves the locking member 164 free to be in its unlocked configuration and a deployed position, shown in FIGS. 5 and 9, in which it forces the locking member 164 into its locked configuration.

For this purpose, the movable member 210 delimits the second 182 of the stops 180, 182 between which the locking member 164 is embedded. The locking member 164 is thus interposed, in the direction of translation of the movable member 210, between the movable member 210 and a stop integral with the frame 72, here the stop 180, so that each deformable element 200 is compressed between the movable member 210 and the stop 180 when the movable member 210 is in the deployed position and is at rest (or, more generally, less compressed) when the movable member 210 is in the retracted position.

The translation direction of the movable member 210 between its retracted and deployed positions is in particular the longitudinal direction (that is to say parallel to the longitudinal axis X).

In the example shown, the movable member 210 is housed in the recess 184, between the locking member 164 and the shoulder 189.

The movable member 210 extends around the axis X. Here, it comprises a ring 212 delimiting the stop 182. The stop 182 is thus annular. As a variant (not shown), the stop 182 is carried by arms projecting longitudinally from a synchronizing ring; the stop 182 is then formed of several sections spaced circumferentially from each other.

Still with reference to FIGS. 5, 6, 8 and 9, the locking device 160 further comprises a biasing member 220 which urges the movable member 210 toward its deployed position, and a holding device 222 for holding the movable member 210 in its retracted position under certain predetermined conditions, typically when the third pressure is greater than a threshold.

Thanks to the biasing member 220, the position of the movable member 210 at rest is the deployed position. This allows to force the locking member 164 into its locked configuration even in the event of a breakdown.

The biasing member 220 is here constituted by a compression spring compressed between the frame 72 and a shoulder 224 integral with the movable member 210. In particular, said compression spring is compressed between the shoulder 189 of the recess 184 and said shoulder 224.

The holding device 222 comprises a counterbalancing cylinder 230 including a counterbalancing piston 232 and a counterbalancing chamber 234.

The counterbalancing piston 232 is mounted to move in translation along the longitudinal axis X with respect to the frame 72. Here, it delimits the shoulder 224 against which the biasing member 220 bears.

The counterbalancing piston 232 is in particular coaxial with the movable member 210. In the example shown, it is constituted by the movable member 210, which allows to gain in compactness.

The counterbalancing chamber 234 is delimited between the counterbalancing piston 232 and the frame 72. In particular, the counterbalancing chamber 234 is delimited longitudinally between the stops 180, 182.

Advantageously, the counterbalancing chamber 234 is also delimited radially between the bottom 187 of the recess 184 and the locking member 164. For this purpose, the locking member 164 is impermeable to the control fluid and forms a sealed contact with each of the stops 180, 182. This allows, in particular in the embodiment of FIGS. 7 to 9, that the part of the locking member 164 oriented toward the surface 162 and which engages with the surface 162 in the locked configuration does not bathe in the control fluid. Thus, the coefficient of friction between the locking member 164 and the surface 162 is increased, which allows to reduce the size of the locking member 164 and therefore to gain in compactness.

The counterbalancing chamber 234 is fluidically connected to the pressure generator 130 by a fluid connection circuit 238 (FIGS. 3 and 7) so as to be supplied with control fluid at the third pressure. It is intended to counterbalance the urge of the biasing device 220 when this supply is active.

For this purpose, the counterbalancing actuator 230 is arranged so that the pressure exerted on the piston 232 by the fluid contained in the chamber 234 is oriented in a direction opposite to that of the urge of the biasing device 230. For this purpose, the counterbalancing piston 232 is, in the example shown, interposed between the chamber 234 and the shoulder 224 and the shoulder 224 is interposed between the piston 232 and the biasing device 220. In addition, the counterbalancing piston 232 and the counterbalancing chamber 234 are dimensioned so that, when the chamber 234 is supplied with control fluid at a pressure above the threshold, the force exerted by the control fluid on the piston 232 is greater than the urge of the biasing device 220.

Thus, as long as the pressure supplied to the chamber 234 is greater than the threshold, the urge of the biasing device 220 is canceled and the movable member 210 is maintained in the retracted position. On the other hand, when the chamber 234 is no longer supplied with control fluid at a pressure greater than the threshold, typically when the pressure generator 130 fails, the force of the biasing device 220 prevails and the movable member 210 is switched into its deployed position.

With reference to FIGS. 3 and 7, the pressure control unit 132 is here fluidly interposed between the pressure generator 130 and the fluid connection circuit 238. It has a first configuration, in which it isolates the fluid connection circuit 238 from the return line 136, and a second configuration, in which it fluidly connects the fluid connection circuit 238 to the return line 136.

The pressure control unit 132 is configured to normally be in its first configuration and to switch to its second configuration upon receiving a control instruction transmitted by the control module 135.

A method for changing the pitch of the blades 56, implemented by the pitch changing mechanism 70, will now be described.

In a first step of this method, the control module 135 first receives a setting instruction to increase the pitch of the blades 56. The control module 135 then transmits to the pressure control unit 132 a control signal to increase the fluid pressure in the first chamber 112. As the fluid pressure in the first chamber 112 increases, the movable part 102 of the actuator 74 moves in the second direction, toward its deployed position, which, via the connecting system 78, causes the blades 56 to pivot toward the large pitches (that is to say toward the feathered position).

Under the effect of its own elasticity and the pressure in the counterbalancing chamber 234, the locking member 164 remains in the unlocked configuration away from the cylindrical surface 162 and therefore does not oppose the movement of the movable part 102.

Once the movable part 102 has reached an equilibrium position, it stabilizes, the blades 56 maintaining a fixed orientation.

In a second step of the pitch change method, the control module 135 first receives a setting instruction to reduce the pitch of the blades 56. The control module 135 then transmits to the pressure control unit 132 a control signal to increase the fluid pressure in the second chamber 114. As the fluid pressure in the second chamber 114 increases, the movable part 102 of the actuator 74 moves in the first direction toward its retracted position, which, via the connecting system 78, causes the blades 56 to pivot toward the small pitches (that is to say, toward the zero thrust position).

Under the effect of its own elasticity and the pressure in the counterbalancing chamber 234, the locking member 164 remains in the unlocked configuration away from the cylindrical surface 162 and therefore does not oppose the movement of the movable part 102.

Once the movable part 102 has reached an equilibrium position, it stabilizes, the blades 56 maintaining a fixed orientation.

Optionally, the pitch change method also comprises, after the first or second step, a step of controlled locking of the orientation of the blades 56.

During this step, the control module 135 transmits a pitch lock control to the pressure control unit 132. Under the effect of this control, the pressure control unit 132 fluidly connects the fluid connection circuit 256 to the return line 136, causing a drop in the fluid pressure in the counterbalancing chamber 234. The fluid pressure in said chamber 234 then falls below the threshold and is therefore insufficient to counterbalance the urge of the biasing device 220, which thus causes the deployment of the movable member 210. The latter then compresses the locking member 164 against the stop 180, which forces the radial expansion of the deformable elements and causes the locking member 164 to switch into its locked configuration.

The movable part 102 can then no longer move with respect to the fixed part 100. The blades 56 are thus locked in their orientation even in the event of loss of fluid pressure in one of the chambers 112, 114.

In the event of a malfunction of the control system 76, typically in the event of a failure of the pressure generator 130, the pitch change method comprises an additional step of non-controlled locking of the orientation of the blades 56.

During this step, the malfunction of the control system 76 causes a drop in the fluid pressure in the counterbalancing chamber 234, typically because the pressure generator 130 is no longer able to raise the third pressure beyond the threshold. The fluid pressure in said chamber 234 is then insufficient to counterbalance the urge of the biasing device 220, which thus causes the deployment of the movable member 210. The latter then compresses the locking member 164 against the stop 180, which forces the radial expansion of the deformable elements and causes the locking member 164 to switch into its locked configuration.

The movable part 102 can then no longer move with respect to the fixed part 100. The blades 56 are thus locked in their orientation.

The non-controlled locking step is preferably followed by a step of securing the fan 50. During this step, the emergency circuit 134 is activated and supplies the first fluid chamber 112 and the counterbalancing chamber 234 with control fluid so as to increase the fluid pressure in these chambers. Under the effect of the increase in pressure in the chamber 234, the movable member 210 retracts and the locking member 164 returns to the unlocked configuration. The movable part 102 is therefore no longer immobilized and can move downstream under the effect of the increase in pressure in the first fluid chamber 112 until the blades 56 are in the feathered position.

It should be noted that these different steps can be implemented independently of each other.

Thus, thanks to the exemplary embodiments described above, it is possible, in a simple and robust manner, to lock the current orientation of the blades 56 (with a certain tolerance). This locking is made possible even in the absence of power supply to the actuator 74 and even with a small force. And this locking is permitted without a significant increase in the size of the mechanism 70.

Moreover, the exemplary embodiment of FIGS. 3 to 5 proves to be particularly radially compact and to simplify the design of the mechanism 70 by facilitating the supply of the counterbalancing chamber 234 via the oil transfer bearing 84.

The exemplary embodiment of FIGS. 7 to 9, in turn, is particularly compact longitudinally and allows to have a counterbalancing chamber 234 with a larger radial section.

It will be noted that, although the above description has been given for the embodiment in which the cylindrical surface 162 is movable jointly with the movable part 102 with respect to the frame 72, the invention is in no way limited to this single embodiment. Thus, in another embodiment (not shown), it is the locking member 164 which is movable jointly with the movable part 102 with respect to the frame 72, the cylindrical surface 162 then being integral with the frame 72.

1. A pitch-change mechanism for adjusting an angular position of at least one variable-setting blade of an aircraft turbomachine around a pivot axis of the variable-setting blade, said pitch-change mechanism comprising:
a frame fixed relative to the pivot axis,
a control actuator including a fixed part integral with the frame and a movable part that is translatable along a longitudinal axis with respect to the fixed part between a retracted position and a deployed position,
a connecting system connecting the movable part to the variable-setting blade so as to convert the translation of the movable part along the longitudinal axis into a rotation of the variable-setting blade around the pivot axis, and
a pitch locking device suitable for locking the translation of the movable part with respect to the fixed part in at least one direction,
wherein the pitch locking device comprises:
a surface integral with the frame or movable jointly with the movable part with respect to the frame,
a locking member having an unlocked configuration away from the surface and a locked configuration engaged with the surface such that the movable part is immobilized with respect to the frame,
a movable member that is translatable with respect to the locking member between a retracted position in which it leaves the locking member free to be in its unlocked configuration and a deployed position in which it forces the locking member into its locked configuration,
a biasing member which urges the movable member toward its deployed position, and
a holding device for holding the movable member in its retracted position under certain predetermined conditions, and wherein the locking member comprises at least one deformable element elastically deformable, having at rest a first radial thickness and, when compressed parallel to the longitudinal axis, a second radial thickness greater than the first radial thickness, the locking member being in the unlocked configuration when the deformable element is at rest and in the locked configuration when the deformable element is compressed parallel to the longitudinal axis.

2. The pitch-change mechanism according to claim 1, wherein the locking member is interposed, in the direction of translation of the movable member between the movable member and a stop so that the or each deformable element is compressed between the movable member and the stop when the movable member is in the deployed position, the or each deformable element preferably being at rest when the movable member is in the retracted position.

3. The pitch-change mechanism according to claim 1, wherein the or each deformable element is formed from a material having a strictly positive Poisson's ratio.

4. The pitch-change mechanism according to claim 1, wherein the or each deformable element is annular.

5. The pitch-change mechanism according to claim 1, wherein the surface is cylindrical.

6. The pitch-change mechanism according to claim 5, wherein the or each deformable element is annular and substantially coaxial with the surface.

7. A fan rotor for a turbomachine comprising a hub and a plurality of variable-setting blades each pivotable relative to the hub around a specific pivot axis, the rotor further comprising the pitch-change mechanism according to claim 1 for adjusting an angular position of each of the variable-setting blades around its respective pivot axis.

8. A gas turbine engine comprising the fan rotor according to claim 7.

9. An aircraft comprising the gas turbine engine according to claim 8.

10. A method for changing the pitch of the blades of a fan rotor for a turbomachine, each pivotable relative to a hub of the fan rotor around a specific pivot axis, said method comprising adjusting an angular position of each of said blades around its respective pivot axis by means of the pitch changing mechanism according to claim 1.

11. The pitch-change mechanism according to claim 3, wherein the Poisson's ratio of the material of the or each deformable element is greater than 0.4.

12. The pitch-change mechanism according to claim 3, wherein the Poisson's ratio of the material of the or each deformable element is greater than 0.45.

13. The pitch-change mechanism according to claim 3, wherein the Poisson's ratio of the material of the or each deformable element is greater than 0.49.

14. The pitch-change mechanism according to claim 5, wherein the surface is substantially coaxial with the longitudinal axis.
